(19) United States
(12) Patent Application Publication
(10) Pub. No.: US 2024/0287845 A1
(43) Pub. Date: Aug. 29, 2024

(54) OPERATION ASSISTANCE SYSTEM AND CONTROL DEVICE

(71) Applicant: AISIN CORPORATION, Kariya (JP)

(72) Inventors: Ryu GOTO, Kariya-shi (JP); Ryu MIYASHIRO, Kariya-shi (JP); Maiko ITO, Kariya-shi (JP)

(73) Assignee: AISIN CORPORATION, Kariya (JP)

(21) Appl. No.: 18/421,028

(22) Filed: Jan. 24, 2024

(30) Foreign Application Priority Data
Feb. 24, 2023 (JP) 2023-027673

(51) Int. Cl. E05F 15/73; E05F 15/60

(52) U.S. Cl. CPC E05F 15/73; E05F 15/60; E05Y 2400/44; E05Y 2900/531

(57) ABSTRACT

An operation assistance system for assisting a user in operating an opening and closing portion includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of opening or closing the opening and closing portion when the user applies a force to the opening and closing portion; and a drive control unit configured to control the drive unit to reduce an operation force of the user required for the manual operation when the manual operation is detected. The manual operation detection unit determines that the manual operation is performed when a difference value between the acceleration applied to the opening and closing portion and an average acceleration that is an average value of the accelerations in a predetermined period is equal to or larger than a first threshold.

### CROSS REFERENCE TO RELATED APPLICATIONS

This application is based on and claims priority under 35 U.S.C. § 119 to Japanese Patent Application 2023-027673, filed on Feb. 24, 2023, the entire content of which is incorporated herein by reference.

### TECHNICAL FIELD

This disclosure relates to an operation assistance system and a control device.

### BACKGROUND DISCUSSION

In a moving body such as a vehicle, a system is used in which, when a user operates an opening and closing portion such as a door, the opening and closing portion is driven to assist the operation of the user.

Examples of the related art include WO 2020/193264 (Reference 1).

In the above system, there is a case where a manual operation performed by the user on the opening and closing portion is to be detected based on an acceleration applied to the opening and closing portion, and when the manual operation is detected, an assistance action of generating a driving force (assist force) for reducing an operation force of the user required for the manual operation is to be performed. In such a case, when the detected acceleration includes noise due to a disturbance other than the manual operation, the manual operation may be erroneously detected, and the assistance action may malfunction.

A need thus exists for an operation assistance system and a control device which are not susceptible to the drawback mentioned above.

### SUMMARY

An aspect of this disclosure relates to an operation assistance system for assisting a user in operating an opening and closing portion, and the operation assistance system includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of opening or closing the opening and closing portion when the user applies a force to the opening and closing portion; and a drive control unit configured to control the drive unit to reduce an operation force of the user required for the manual operation when the manual operation is detected. The manual operation detection unit determines that the manual operation is performed when a difference value between the acceleration applied to the opening and closing portion and an average acceleration that is an average value of the accelerations in a predetermined period is equal to or larger than a first threshold.

Another aspect of this disclosure relates to a control device that executes processing for controlling a drive unit that generates a driving force for displacing an opening and closing portion, and the control device includes: a manual operation detection unit configured to detect, based on an acceleration applied to the opening and closing portion, a manual operation of opening or closing the opening and closing portion when a user applies a force to the opening and closing portion; and a drive control unit configured to control the drive unit to reduce an operation force of the user required for the manual operation when the manual operation is detected. The manual operation detection unit determines that the manual operation is performed when a difference value between the acceleration applied to the opening and closing portion and an average acceleration that is an average value of the accelerations in a predetermined period is equal to or larger than a first threshold.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram showing an example of a system configuration of an operation assistance system according to a first embodiment;

FIG. 2 is a diagram showing an example of a functional configuration of an ECU according to the first embodiment;

FIG. 3 is a diagram showing an example of time-series changes in an acceleration and an average acceleration according to the first embodiment;

FIG. 4 is a diagram showing an example of time-series changes in a difference value according to the first embodiment;

FIG. 5 is a diagram showing an example of a relationship among a post-HPF acceleration when a disturbance is present, a pre-HPF acceleration, and a difference value according to the first embodiment;

FIG. 6 is a diagram showing an example of a relationship between a post-HPF acceleration when no disturbance is present and a pre-HPF acceleration according to the first embodiment;

FIG. 7 is a flowchart showing an example of processing executed by the ECU according to the embodiment;

FIG. 8 is a diagram showing an example of a relationship between a post-HPF acceleration when a disturbance is present and first thresholds according to a second embodiment; and

FIG. 9 is a flowchart showing an example of processing executed by an ECU according to the second embodiment.

### DETAILED DESCRIPTION

Hereinafter, exemplary embodiments disclosed here will be disclosed. Configurations of embodiments to be described below, and operations, results, and effects of the configurations are examples. Embodiments disclosed here can be implemented by configurations other than the configurations disclosed in the embodiments to be described below, and at least one of various effects based on a basic configuration and a derivative effect can be obtained.

### First Embodiment

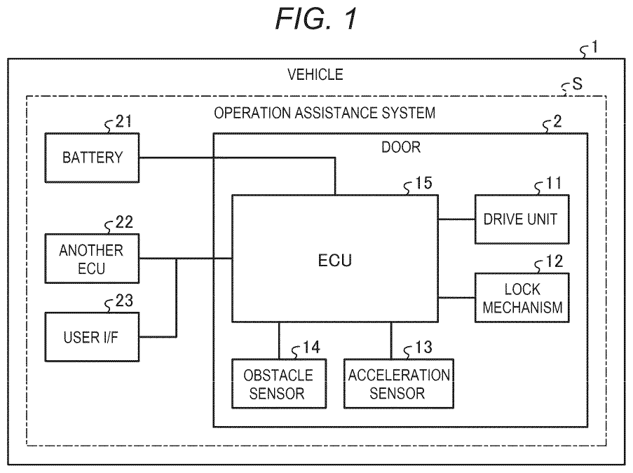

FIG. 1 is a diagram showing an example of a system configuration of an operation assistance system S according to a first embodiment. The operation assistance system S according to the embodiment is a system that assists a user (occupant) in operating a door 2 (an example of an opening and closing portion) mounted on a vehicle 1 such as a four-wheel automobile. The door 2 according to the embodiment is a hinge door that is opened and closed when the user gets on and off the vehicle 1.

The operation assistance system S includes a drive unit 11 (an example of a drive unit), a lock mechanism 12, an acceleration sensor 13 (an example of a sensor), an obstacle sensor 14, and an electronic control unit (ECU) 15 (an example of a control device).

The drive unit 11 is a unit that generates a driving force for displacing the door 2, and may be implemented by using an actuator including an electric motor, a link mechanism, or the like. The drive unit 11 is installed on, for example, a hinge portion of the door 2, and generates the driving force for displacing the door 2 in an opening direction or a closing direction according to a control signal from the ECU 15 to be described later.

The lock mechanism 12 is a mechanism that switches the door 2 between a locked state and a released state. The lock mechanism 12 according to the embodiment includes an actuator that is electrically operated according to a control signal from the ECU 15, and switches between the locked state and the released state according to the control signal.

The acceleration sensor 13 is a sensor that detects an acceleration applied to the door 2. The acceleration sensor 13 may be, for example, a three-axis acceleration sensor capable of detecting an acceleration in each of an X direction, a Y direction, and a Z direction orthogonal to one another. The X direction, the Y direction, and the Z direction may be, for example, a width (left-right) direction, a front-rear direction, and an upper-lower direction of the vehicle 1, respectively. The acceleration sensor 13 is installed inside the door 2. The acceleration sensor 13 may be integrated with the ECU 15.

The obstacle sensor 14 is a sensor that detects an obstacle present around the vehicle 1. The obstacle sensor 14 is, for example, a distance sensor capable of measuring a distance from a vehicle body (such as the door 2) to the obstacle, and may be, for example, an ultrasonic sensor, a millimeter wave sensor, or a light detection and ranging (LiDAR) sensor.

The ECU 15 is an information processing device that controls the drive unit 11 and the lock mechanism 12.

The ECU 15 may be implemented by using a central processing unit (CPU), a memory, a field programmable gate array (FPGA), an application specific integrated circuit (ASIC), an input interface (I/F), an output I/F, or the like. The ECU 15 is connected to a battery 21 mounted on the vehicle 1 via a predetermined power transmission path. The ECU 15 is connected to another ECU 22, a user I/F 23, and the like mounted on the vehicle 1 via a communication network such as a controller area network (CAN). Another ECU 22 may be, for example, an ECU that executes processing for controlling traveling of the vehicle 1. The user I/F 23 may be, for example, an operation unit that is mounted in the vehicle and allows the user (occupant) to perform a setting operation or the like.

The ECU 15 according to the embodiment executes processing for controlling the drive unit 11 and the like so as to assist the user in operating the door 2 based on information acquired from the acceleration sensor 13 and the like.

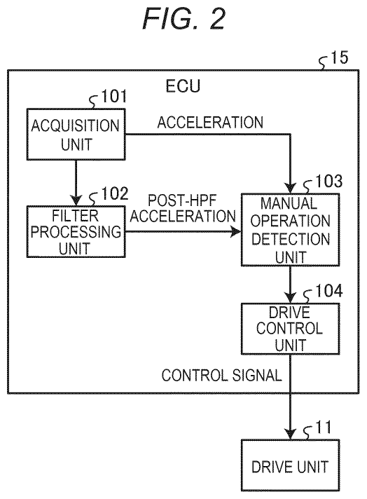

FIG. 2 is a diagram showing an example of a functional configuration of the ECU 15 according to the first embodiment. The ECU 15 includes an acquisition unit 101, a filter processing unit 102, a manual operation detection unit 103, and a drive control unit 104. The functional units 101 to 104 are implemented by cooperation between hardware (such as a CPU) and software (such as a program stored in a memory) constituting the ECU 15. At least one of the functional units 101 to 104 may include dedicated hardware (such as a circuit).

The acquisition unit 101 acquires acceleration information indicating the acceleration applied to the door 2 from the acceleration sensor 13. The acceleration information includes information indicating time-series changes in the acceleration instantaneously applied to the door 2, and the like.

The filter processing unit 102 executes predetermined filter processing on the acceleration information acquired by the acquisition unit 101. The filter processing according to the embodiment executes a high-pass filter (HPF) and outputs a post-HPF acceleration. The HPF according to the embodiment is processing of extracting a component at a frequency higher than a predetermined cutoff frequency from the acceleration detected by the acceleration sensor 13. For example, the HPF may act to increase a value of the acceleration that varies at a frequency higher than the cutoff frequency.

The post-HPF acceleration can be calculated, for example, by the following equation (1). In the equation (1), afilₙ represents the post-HPF acceleration, an represents a current acceleration, aₙ₋₁ represents an acceleration in a previous cycle, afilₙ₋₁ represents a post-HPF acceleration in a previous cycle, T represents a time for one cycle, and f_{c} represents the cutoff frequency. The calculation method is an example, and a method for calculating the post-HPF acceleration is not limited thereto.

$${afil}_{n} = \frac{1}{π {f}_{c} T + 1} {a}_{n} - \frac{1}{π {f}_{c} T + 1} {a}_{n - 1} - \frac{π {f}_{c} T - 1}{π {f}_{c} T + 1} {afil}_{n - 1} \qquad ( 1 )$$

The manual operation detection unit 103 detects a manual operation of opening or closing the door 2 when the user applies a force to the door 2 based on the acceleration information (the acceleration detected by the acceleration sensor 13) acquired by the acquisition unit 101.

When a manual operation is detected by the manual operation detection unit 103, the drive control unit 104 controls the drive unit 11 to generate a driving force (assist force) for reducing an operation force of the user required for the manual operation.

The manual operation detection unit 103 according to the embodiment has a function of preventing erroneous detection of a manual operation. Specifically, the manual operation detection unit 103 determines that a manual operation is performed when a difference value between an acceleration (instantaneous acceleration) applied to the door 2 and an average acceleration that is an average value of the accelerations in a predetermined period is equal to or larger than a predetermined first threshold.

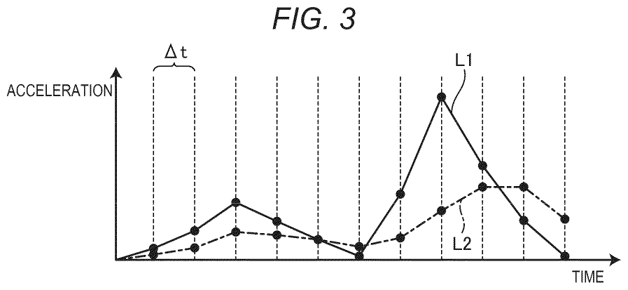

FIG. 3 is a diagram showing an example of time-series changes in the acceleration and the average acceleration according to the first embodiment. FIG. 3 shows a line L1 indicating time-series changes in the instantaneous acceleration and a line L2 indicating time-series changes in the average acceleration. A value of an acceleration at each time point on the line L1 is the instantaneous acceleration detected by the acceleration sensor 13 every predetermined cycle Δt. A value of an average acceleration at each time point on the line L2 is the average value of a plurality of instantaneous accelerations detected within the predetermined period (for example, a period corresponding to a plurality of cycles Δt), and can be calculated using an appropriate method such as moving averaging.

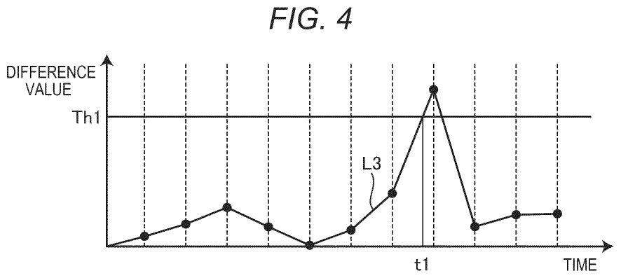

FIG. 4 is a diagram showing an example of time-series changes in the difference value according to the first embodiment. FIG. 4 shows a line L3 indicating the time-series changes in the difference value between the instantaneous acceleration (line L1 in FIG. 3) and the average acceleration (line L2 in FIG. 3).

When the difference value is equal to or larger than a predetermined first threshold Th1, the manual operation detection unit 103 according to the embodiment determines that the user performs (starts) a manual operation. In the example shown in FIG. 4, it is determined that the manual operation is performed at a time point t1.

The acceleration applied to the door 2 may instantaneously increase due to a disturbance other than the manual operation performed by the user on the door 2. The disturbance may be, for example, opening and closing of a door other than the target door 2, an action of an occupant inside the vehicle, and a vibration applied to the vehicle body from the outside. Therefore, as in the embodiment, by determining presence or absence of the manual operation based on the difference value between the instantaneous acceleration and the average acceleration, a possibility of erroneously determining that the manual operation is performed can be reduced even when the acceleration instantaneously increases due to the disturbance.

The manual operation detection unit 103 according to the embodiment determines presence or absence of the disturbance based on the post-HPF acceleration (an acceleration after the HPF is applied by the filter processing unit 102), and prohibits detection of the manual operation for a predetermined period when determining that the disturbance is present. Specifically, the detection of the manual operation is prohibited until a predetermined prohibition period elapses from when the post-HPF acceleration becomes equal to or larger than a predetermined second threshold.

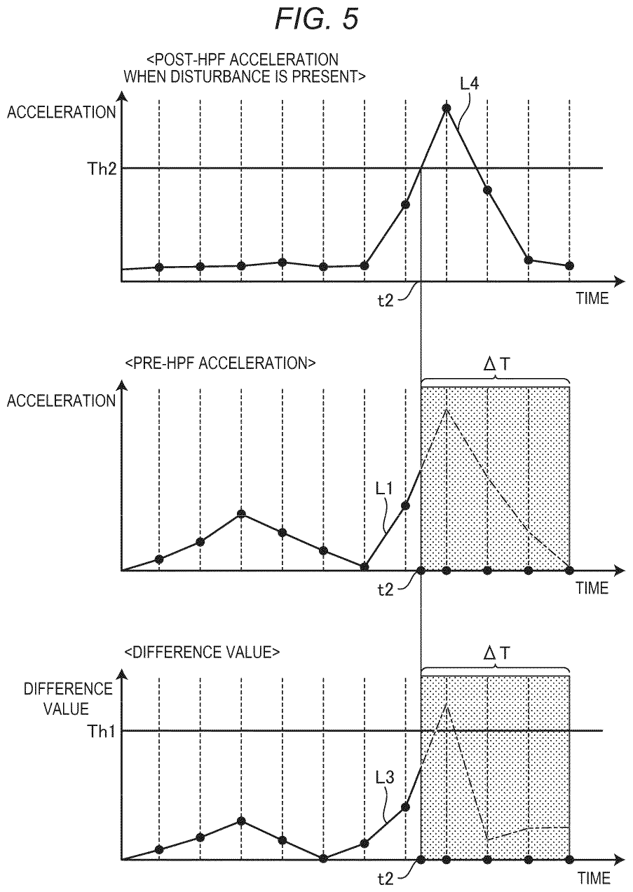

FIG. 5 is a diagram showing an example of a relationship among a post-HPF acceleration when a disturbance is present, a pre-HPF acceleration, and a difference value according to the first embodiment. FIG. 5 shows a line L4 indicating time-series changes in the post-HPF acceleration when the disturbance is present, the line L1 indicating time-series changes in the pre-HPF acceleration, and the line L3 indicating time-series changes in the difference value. It is assumed that time series of the lines L4, L1, and L3 coincide with one another.

The line L4 shown here corresponds to the post-HPF acceleration when the disturbance is present. For example, if the disturbance such as an impact occurs when a door other than the target door 2 is closed, a high-frequency variation occurs in the acceleration detected by the acceleration sensor 13 mounted on the target door 2, and a phenomenon occurs in which the post-HPF acceleration increases as shown by the line L4.

As shown in FIG. 5, the manual operation detection unit 103 according to the embodiment masks a value of the pre-HPF acceleration corresponding to the post-HPF acceleration until a predetermined prohibition period ΔT elapses from a time point t2 when the post-HPF acceleration is equal to or larger than a second threshold Th2. In this example, as shown in a middle graph in FIG. 5, the pre-HPF acceleration in the prohibition period ΔT is 0. Accordingly, the difference value in the prohibition period ΔT is also 0.

As described above, in the embodiment, presence or absence of a disturbance is to be post-HPF acceleration, and when it is determined that the disturbance is present, the detection of the manual operation is prohibited until the predetermined prohibition period ΔT elapses. By such processing, erroneous detection of the manual operation due to the disturbance can be more reliably prevented.

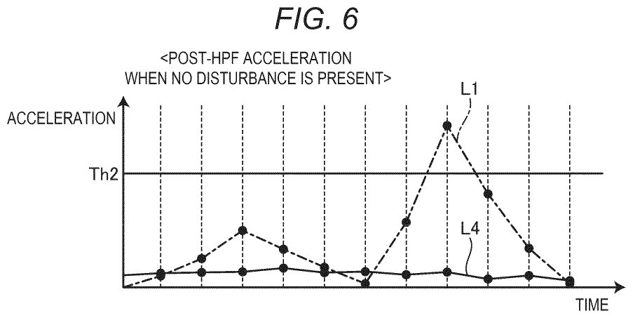

FIG. 6 is a diagram showing an example of a relationship between a post-HPF acceleration when no disturbance is present and a pre-HPF acceleration according to the first embodiment. FIG. 6 shows the line L1 indicating time-series changes in the pre-HPF acceleration and the line L4 derived based on the line L1 and indicating time-series changes in the post-HPF acceleration when no disturbance is present. As shown in FIG. 6, when no disturbance is present, a value of the post-HPF acceleration remains low even if the pre-HPF acceleration greatly varies.

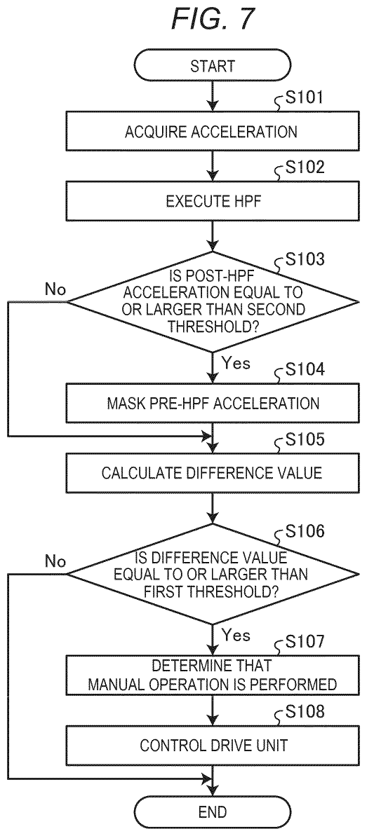

FIG. 7 is a flowchart showing an example of processing executed by the ECU 15 according to the first embodiment. When the acquisition unit 101 acquires an acceleration detected by the acceleration sensor 13 (S101), the filter processing unit 102 executes HPF on the acceleration (S102), and the manual operation detection unit 103 determines whether a post-HPF acceleration is equal to or larger than the second threshold Th2 (S103).

When the post-HPF acceleration is smaller than the second threshold Th2 (S103: No), that is, when no disturbance is present (influence of a disturbance is sufficiently small), the manual operation detection unit 103 calculates a difference value based on a pre-HPF acceleration (S105) (see FIGS. 3 and 4). On the other hand, when the post-HPF acceleration is equal to or larger than the second threshold Th2 (S103: Yes), that is, when a disturbance is present (influence of a disturbance is large), the manual operation detection unit 103 masks a pre-HPF acceleration until the prohibition period ΔT elapses (S104), and calculates a difference value based on the masked pre-HPF acceleration (S105) (see FIG. 5).

Thereafter, the manual operation detection unit 103 determines whether the difference value calculated as described above is equal to or larger than the first threshold Th1 (S106). When the difference value is equal to or larger than the first threshold Th1 (S106: Yes), the manual operation detection unit 103 determines that a manual operation is performed (S107), and the drive control unit 104 controls the drive unit 11 to reduce an operation force of the user required for the manual operation (S108). On the other hand, when the difference value is smaller than the first threshold Th1 (S106: No), it is determined that no manual operation is performed, and this routine is ends.

According to the above embodiment, presence or absence of the manual operation is determined based on a difference value between an instantaneous acceleration detected by the acceleration sensor 13 and an average acceleration. Accordingly, even when the acceleration instantaneously increases due to the disturbance, it is possible to prevent erroneous detection of the manual operation, and to prevent malfunction of an assistance action performed by the drive unit 11. Presence or absence of the disturbance is to be determined based on the post-HPF acceleration, and when it is determined that the disturbance is present, detection of the manual operation is prohibited until the predetermined prohibition period ΔT elapses. Accordingly, an effect of preventing erroneous detection of the manual operation due to the disturbance can be improved.

### Second Embodiment

In the first embodiment, when it is determined that a disturbance is present based on a post-HPF acceleration (the post-HPF acceleration is equal to or larger than the second threshold Th2), a pre-HPF acceleration is masked until the predetermined prohibition period ΔT elapses, and detection of a manual operation is prohibited. However, processing after it is determined that the disturbance is present is not limited to thereto. In the embodiment, when it is determined that a disturbance is present based on a post-HPF acceleration, the first threshold Th1 is corrected to a value larger than a value corresponding to a period other than the prohibition period ΔT.

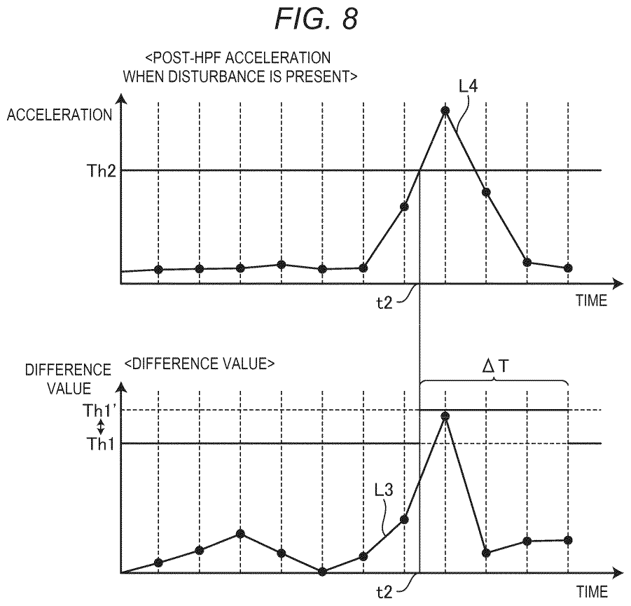

FIG. 8 is a diagram showing an example of a relationship between a post-HPF acceleration when a disturbance is present and first thresholds Th1 and Th1′ according to a second embodiment. FIG. 8 shows the line L4 indicating time-series changes in the post-HPF acceleration when the disturbance is present, the line L3 indicating time-series changes in a difference value, and the first thresholds Th1 and Th1′.

In the embodiment, as shown in FIG. 8, the first threshold is corrected from a value Th1 to a value Th1′ until the prohibition period ΔT elapses from the time point t2 when the post-HPF acceleration reaches the second threshold Th2. The value Th1′ corresponding to the prohibition period ΔT is larger than the value Th1 corresponding to a period other than the prohibition period ΔT. By correcting the first threshold in this manner, a manual operation is less likely to be detected in the prohibition period ΔT. With such a method, an effect of preventing erroneous detection of the manual operation due to a disturbance can also be improved.

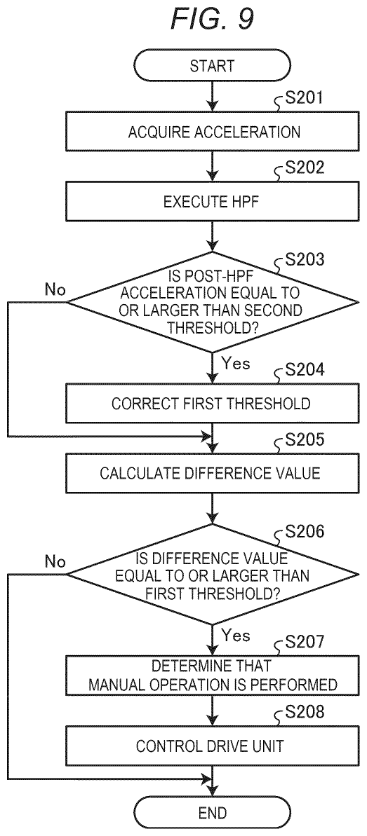

FIG. 9 is a flowchart showing an example of processing executed by the ECU 15 according to the second embodiment. When the acquisition unit 101 acquires an acceleration detected by the acceleration sensor 13 (S201), the filter processing unit 102 executes HPF on the acceleration (S202), and the manual operation detection unit 103 determines whether a post-HPF acceleration is equal to or larger than the second threshold Th2 (S203).

When the post-HPF acceleration is smaller than the second threshold Th2 (S203: No), that is, when no disturbance is present (influence of a disturbance is sufficiently small), the manual operation detection unit 103 calculates a difference value based on a pre-HPF acceleration (S205) (see FIGS. 3 and 4). On the other hand, when the post-HPF acceleration is equal to or larger than the second threshold Th2 (S203: Yes), that is, when a disturbance is present (influence of a disturbance is large), the manual operation detection unit 103 corrects the first threshold during the prohibition period ΔT to the value Th1′ larger than the value Th1 corresponding to a period other than the prohibition period ΔT (S204), and then calculates a difference value based on a pre-HPF acceleration (S205).

Thereafter, the manual operation detection unit 103 determines whether the difference value is equal to or larger than the first threshold Th1 or Th1′ (S206). At this time, the first threshold is the normal value Th1 when the post-HPF acceleration is smaller than the second threshold Th2 (S203: No), and is the value Th1′ larger than the value Th1 when the post-HPF acceleration is equal to or larger than the second threshold Th2 (S203: Yes).

When the difference value is equal to or larger than the first threshold Th1 or Th1′ (S206: Yes), the manual operation detection unit 103 determines that a manual operation is performed (S207), and the drive control unit 104 controls the drive unit 11 to reduce an operation force of the user required for the manual operation (S208). On the other hand, when the difference value is smaller than the first threshold Th1 or Th1′ (S206: No), it is determined that no manual operation is performed, and this routine ends.

As described above, according to the embodiment, the first threshold is corrected to the value Th1′ larger than the value Th1 until the prohibition period ΔT elapses from the time point t2 when the post-HPF acceleration reaches the second threshold Th2. By correcting the first threshold in this manner, the manual operation is less likely to be detected in the prohibition period ΔT. Accordingly, an effect of preventing erroneous detection of the manual operation due to the disturbance can be improved.

### MODIFICATION

In the above embodiment, presence or absence of a disturbance is to be determined based on a post-HPF acceleration, and when it is determined that the disturbance is present, processing of prohibiting detection of a manual operation (first embodiment) and processing of increasing the first threshold Th1 to make detection of a manual operation difficult (second embodiment) are executed, but the processing is not essential. In a configuration in which such processing is omitted, an effect of preventing malfunction of a manual operation can also be obtained.

A program for causing a computer (such as the ECU 15) to execute processing for implementing a function of the operation assistance system S according to the above embodiment or a modification may be provided as a computer program product stored in a computer-readable storage medium such as a CD-ROM, a CD-R, a memory card, a digital versatile disk (DVD), or a flexible disk (FD) in an installable format or an executable format. The program may be stored on a computer connected to a network such as the Internet and provided by being downloaded via the network. The program may be provided or distributed via a network such as the Internet.

An aspect of this disclosure relates to an operation assistance system for assisting a user in operating an opening and closing portion, and the operation assistance system includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of opening or closing the opening and closing portion when the user applies a force to the opening and closing portion; and a drive control unit configured to control the drive unit to reduce an operation force of the user required for the manual operation when the manual operation is detected. The manual operation detection unit determines that the manual operation is performed when a difference value between the acceleration applied to the opening and closing portion and an average acceleration that is an average value of the accelerations in a predetermined period is equal to or larger than a first threshold.

According to the above configuration, presence or absence of the manual operation is determined based on the difference value between the acceleration and the average acceleration. Accordingly, even when the acceleration instantaneously increases due to a disturbance, it is possible to prevent erroneous detection of the manual operation, and to prevent malfunction of an assistance action performed by the drive unit.

In the above configuration, the manual operation detection unit may prohibit detection of the manual operation until a predetermined prohibition period elapses from when an acceleration, after application of a high-pass filter that extracts a component at a frequency higher than a predetermined cutoff frequency from the acceleration detected by the sensor, becomes equal to or larger than a second threshold.

According to the above configuration, presence or absence of a disturbance is to be determined based on the acceleration after the high-pass filter, and when it is determined that the disturbance is present (the acceleration after the high-pass filter is equal to or larger than the second threshold), the detection of the manual operation is prohibited until the predetermined prohibition period elapses. Accordingly, an effect of preventing erroneous detection of the manual operation due to the disturbance can be improved.

In the above configuration, the manual operation detection unit may correct the first threshold to a value larger than a value corresponding to a period other than a predetermined prohibition period until the prohibition period elapses from when an acceleration, after application of a high-pass filter that extracts a component at a frequency higher than a predetermined cutoff frequency from the acceleration detected by the sensor, becomes equal to or larger than a second threshold.

According to the above configuration, presence or absence of a disturbance is to be determined based on the acceleration after the high-pass filter, and when it is determined that the disturbance is present (the acceleration after the high-pass filter is equal to or larger than the second threshold), the first threshold is corrected to a large value until the predetermined prohibition period elapses. Accordingly, it is possible to make it difficult to detect the manual operation in the prohibition period, and an effect of preventing erroneous detection of the manual operation due to the disturbance can be improved.

Another aspect of this disclosure relates to a control device that executes processing for controlling a drive unit that generates a driving force for displacing an opening and closing portion, and the control device includes: a manual operation detection unit configured to detect, based on an acceleration applied to the opening and closing portion, a manual operation of opening or closing the opening and closing portion when a user applies a force to the opening and closing portion; and a drive control unit configured to control the drive unit to reduce an operation force of the user required for the manual operation when the manual operation is detected. The manual operation detection unit determines that the manual operation is performed when a difference value between the acceleration applied to the opening and closing portion and an average acceleration that is an average value of the accelerations in a predetermined period is equal to or larger than a first threshold.

According to the above configuration, presence or absence of the manual operation is determined based on the difference value between the acceleration and the average acceleration. Accordingly, even when the acceleration instantaneously increases due to a disturbance, it is possible to prevent erroneous detection of the manual operation, and to prevent malfunction of an assistance action performed by the drive unit.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An operation assistance system for assisting a user in operating an opening and closing portion, the operation assistance system comprising:
a sensor configured to detect an acceleration applied to the opening and closing portion;
a drive unit configured to generate a driving force for displacing the opening and closing portion;
a manual operation detection unit configured to detect, based on the acceleration detected by the sensor, a manual operation of opening or closing the opening and closing portion when the user applies a force to the opening and closing portion; and
a drive control unit configured to control the drive unit to reduce an operation force of the user required for the manual operation when the manual operation is detected, wherein
the manual operation detection unit determines that the manual operation is performed when a difference value between the acceleration applied to the opening and closing portion and an average acceleration that is an average value of the accelerations in a predetermined period is equal to or larger than a first threshold.

2. The operation assistance system according to claim 1, wherein
the manual operation detection unit prohibits detection of the manual operation until a predetermined prohibition period elapses from when an acceleration, after application of a high-pass filter that extracts a component at a frequency higher than a predetermined cutoff frequency from the acceleration detected by the sensor, becomes equal to or larger than a second threshold.

3. The operation assistance system according to claim 1, wherein
the manual operation detection unit corrects the first threshold to a value larger than a value corresponding to a period other than a predetermined prohibition period until the prohibition period elapses from when an acceleration, after application of a high-pass filter that extracts a component at a frequency higher than a predetermined cutoff frequency from the acceleration detected by the sensor, becomes equal to or larger than a second threshold.

4. A control device that executes processing for controlling a drive unit that generates a driving force for displacing an opening and closing portion, the control device comprising:
a manual operation detection unit configured to detect, based on an acceleration applied to the opening and closing portion, a manual operation of opening or closing the opening and closing portion when a user applies a force to the opening and closing portion; and
a drive control unit configured to control the drive unit to reduce an operation force of the user required for the manual operation when the manual operation is detected, wherein
the manual operation detection unit determines that the manual operation is performed when a difference value between the acceleration applied to the opening and closing portion and an average acceleration that is an average value of the accelerations in a predetermined period is equal to or larger than a first threshold.
